(19) United States
(12) Patent Application Publication
(10) Pub. No.: US 2025/0112818 A1
(43) Pub. Date: Apr. 3, 2025

(54) MONITORING FOR POWER AND/OR INTERNET OUTAGES USING DATA ASSOCIATED WITH PREMISES MONITORING SYSTEMS

(71) Applicant: The ADT Security Corporation, Boca Raton, FL (US)

(72) Inventor: Michael Patrick CORREIA, Tampa, FL (US)

(21) Appl. No.: 18/478,327

(22) Filed: Sep. 29, 2023

(51) Int. Cl. H04L 41/0654; H04L 41/0677

(52) U.S. Cl. CPC H04L 41/0654; H04L 41/0677

(57) ABSTRACT

According to some embodiments, a computing environment is provided and is configured to communicate with a plurality of monitoring control devices, where each of the plurality of monitoring control devices is associated with a respective one of a plurality of premises monitoring systems for monitoring a respective premises. The computing environment is configured to receive a plurality of status reports, correlate each of the plurality of status reports with a respective physical address of a plurality of physical addresses corresponding to the plurality of premises monitoring systems, determine that a power outage and/or internet outage has occurred in a geographical area covering at least a subset of the plurality of addresses based at least on the plurality of status reports received from the monitoring control devices, and initiate at least one action based at least on determining that the power outage and the internet outage has occurred.

### TECHNICAL FIELD

The present technology is generally related to monitoring for internet and/or power outages based at least on data associated with premises monitoring systems.

### BACKGROUND

Outage management systems are used to monitor power outages in respective geographical areas. Outage management systems may input user data via phone calls for performing outage determinations. That is, outage management systems often rely on users reporting information in a timely manner, which may introduce delays in making power outage determinations and where dependability in the user-data may vary. Other outage management systems rely on smart sensors inside the utility meter for providing data that is used to make a power outage determination. However, existing infrastructure can be expensive to upgrade to smart sensors.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example of a networked environment according to various embodiments of the present disclosure;

FIG. 2 is a block diagram of an example of the computing environment and monitoring control device of FIG. 1 according to various embodiments of the present disclosure;

FIGS. 3A and 3B are a flowchart depicting an example of functionality performed by components in the computing environment and monitoring control device of FIG. 1 according to various embodiments of the present disclosure;

FIG. 4 is a diagram of an example of status reports received from various monitoring control devices of FIG. 1 according to various embodiments of the present disclosure;

FIG. 5 is a diagram of another example of status reports received from various monitoring control devices of FIG. 1 according to various embodiments of the present disclosure; and

FIG. 6 is a diagram of another example of status reports received from various monitoring control devices of FIG. 1 according to various embodiments of the present disclosure.

### DETAILED DESCRIPTION

As used herein, relational terms, such as “first” and “second,” “top” and “bottom,” and the like, may be used to distinguish one entity or element from another entity or element without necessarily requiring or implying any physical or logical relationship or order between the entities or elements. The terminology used herein is only for the purpose of describing particular embodiments and is not intended to be limiting of the concepts described herein. As used herein, the singular forms “a”, “an” and “the” are intended to include the plural forms as well, unless the context clearly indicates otherwise. The terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups.

In embodiments described herein, the joining term, “in communication with” and the like, may be used to indicate electrical or data communication, which may be accomplished by physical contact, induction, electromagnetic radiation, radio signaling, infrared signaling or optical signaling, for example. Multiple components may interoperate and modifications and variations are possible to achieve electrical and data communication.

In some embodiments described herein, the term “coupled,” “connected,” and the like, may be used herein to indicate a connection, although not necessarily directly, and may include wired and/or wireless connections.

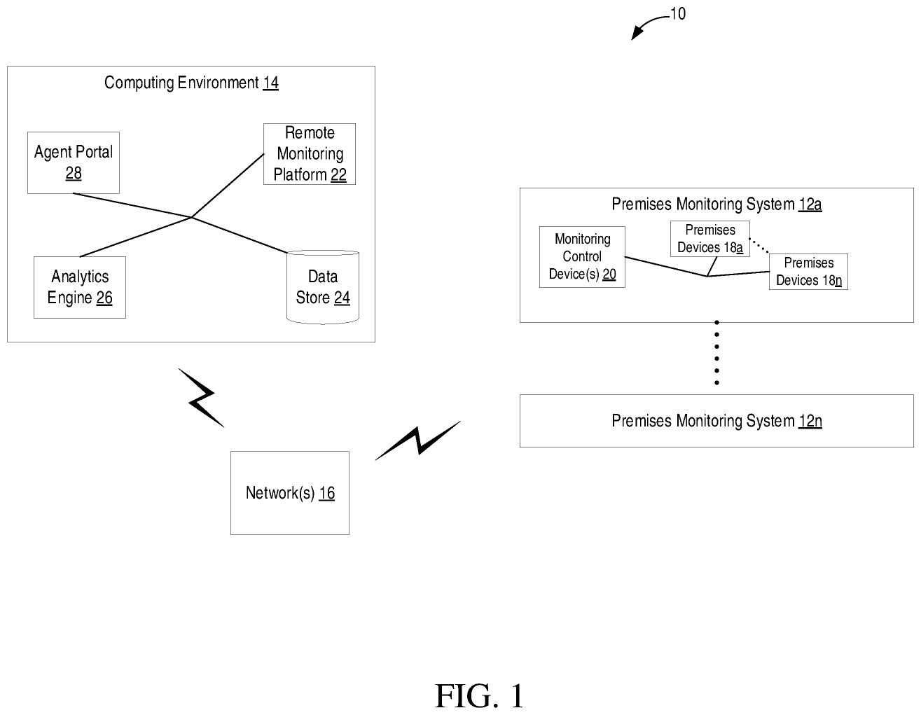

Referring now to the drawing figures, in which like elements are referred to by like reference numerals, there is shown in FIG. 1 is a block diagram of an example of a networked environment 10. Networked environment 10 includes one or more premises monitoring system 12a-12n (collectively referred to as premises monitoring system 12) and computing environment 14 in communication with each other via one or more networks 16 (collectively referred to as “network 16”). Premises monitoring system 12 comprises one or more premises devices 18a-18n (collectively referred to as “premises device 18”) for monitoring a premises. According to various embodiments, the premises monitoring system 12 may be, for example, a burglary alarm system, an alarm system for monitoring the safety of life and/or property, a home automation system, and/or other types of systems for premises monitoring.

In particular, computing environment 14 may monitor in-home premises monitoring systems 12 which may comprise battery power backups and a cellular connection backup connection, where Wi-Fi or other local internet access may provide a primary connection. As part of the monitoring services performed by computing environment 14, data on when Wi-Fi outages occur, as well as when power is no longer applied to the monitoring control device 20 may be collected. This data may be sent to computing environment 14 for analysis, as described herein. In some instances, it may not be possible for the computing environment 14 to determine the exact reason why monitoring control device 20 lost power and/or internet connection. However, computing environment 14 has information or can retrieve customer data such as the physical address of each monitoring control device 20 as computing environment 14 has access to such customer data due, in part, to the monitoring services provided by computing environment 14. Using at least some of the customer data and other data (e.g., status data, geographical data, etc.), computing environment 14 may aggregate, and perform determinations on potential outages.

Still referring to FIG. 1, premises devices 18 may include sensors, image capture devices, audio capture devices, life safety devices, premises automation devices, and/or other devices. For example, the types of sensors may include various life safety-related sensors, such as motion sensors, fire sensors, carbon monoxide sensors, flooding sensors, contact sensors, and other sensor types. Image capture devices may include still cameras and/or video cameras, among other image capture devices. Premises automation devices may include lighting devices, climate control devices, and other types of devices. Premises device 18 may be configured for sensing one or more aspects of premises, such as an open or closed door, open or closed window, motion, heat, smoke, gas, sounds, images, people, animals, objects, etc.

Monitoring control device 20 may be configured for controlling and/or managing the premises monitoring system 12 and/or premises devices 18. To this end, monitoring control device 20 may include components, such as a keypad, buttons, display screen, buzzer, and/or speaker, that may facilitate a user interacting with monitoring control device 20. In some embodiments, monitoring control device 20 may be an alarm system control panel, a keypad, or a home automation hub device. Additionally, a monitoring control device 20 in some embodiments may include a personal computer, smart phone, table computer, etc., with an application, such as a web browser or dedicated application, that facilitates controlling and/or managing the premises monitoring system 12 and/or premises devices 18. In one or more embodiments, monitoring control device is configured to generate and transmit status reports, as described herein. Monitoring control device 20 and premises devices 18 may communicate with each other using various protocols and network topologies. For example, monitoring control device 20 and premises devices 18 may wirelessly communicate using communications compliant with one or more versions of the Z-Wave protocol, Zigbee protocol, Wi-Fi protocol, Thread protocol, Bluetooth protocol, Digital Enhanced Cordless Telecommunications (DECT) protocol, and/or other protocols.

Monitoring control device 20 may be in communication with computing environment 14 via one or more networks 16. Network 16 can include, for example, one or more intranets, extranets, wide area networks (WANs), local area networks (LANs), wired networks, wireless networks, cellular networks, satellite networks, Data Over Cable Service Interface Specification (DOCSIS) networks, cellular networks, Plain Old Telephone Service (POTS) networks, and/or other types of networks. For example, if a local Wi-Fi network is not working at a premises, monitoring control device 20 may be configured to communicate with computing environment 14 using a cellular network.

Still referring to FIG. 1, networked environment 10 includes computing environment 14 having remote monitoring platform 22, data store 24, analytics engine 26 and agent portal 28. Remote monitoring platform 22 may be configured to perform and/or trigger one or more functions and/or processes performed by computing environment 14, such as, for example, functions and/or processes associated with monitoring for power outages and/or internet outages based at least one status reports from various monitoring control devices 20, as described herein.

Data store 24 may be a secure data store that is configured for at least temporary storage of data for retrieval, management and/or analysis. For example, data store 24 may store one or more of status reports, power outage data, internet outage data, backup power source data for one or more premises, physical address information for various premises monitoring systems 12, etc.

Analytics engine 26 may perform one or more analytic functions and/or processes, as described herein. For example, analytics engine 26 may be configured to perform one or more analytic functions and/or processes, such as determining whether a power outage and/or internet outage occurred, as described herein.

Computing environment 14 may also provide one or more agent portals 28 that may facilitate monitoring agents associated with computing environment 14 in initiating and/or performing one or more monitoring actions. For example, in the event that the remote monitoring platform 22 receives status reports and analytics engine 26 determines an outage occurred, the agent portal 28 may render for display various information associated with the outage.

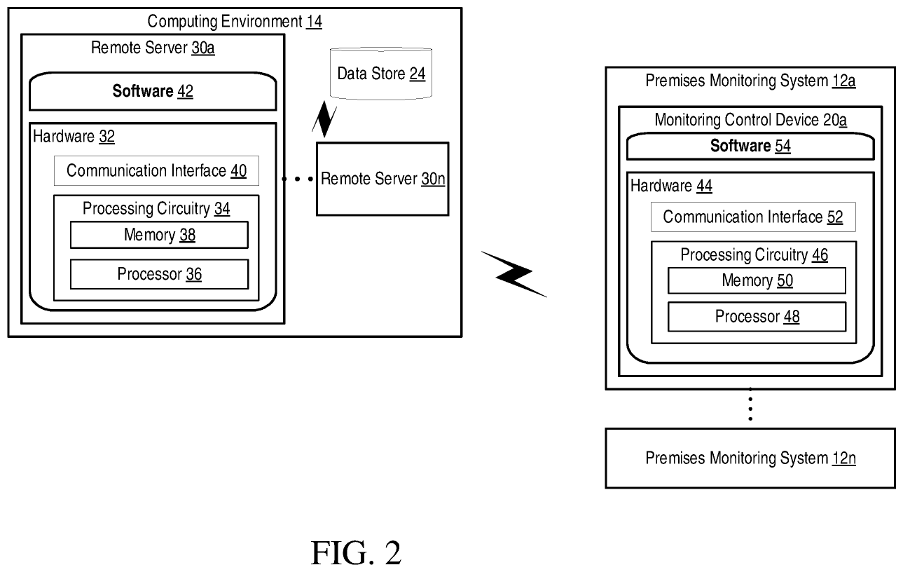

Referring to FIG. 2, shown is a block diagram illustrating examples of various components of computing environment 14 and monitoring control device 20. As shown, computing environment 14 may comprise one or more remote servers 30a-30n (collectively referred to as remote server 30) that are configured to perform one or more computing environment 14 functions that are described herein. In one or more embodiments, remote server 30 may be a computing device. For example, one or more functions of remote monitoring platform 22 and/or analytics engine 26 may be performed in a single remote server 30 or may be distributed among two or more remote servers 30. Each remote server 30 comprises hardware 32. The hardware 32 may include processing circuitry 34. The processing circuitry 34 may include one or more processors 36 and one or more memories 38. Each processor 36 may include and/or be associated with one or more central processing units, data buses, buffers, and interfaces to facilitate operation. In addition to or instead of a processor 36 and memory, the processing circuitry 34 may comprise integrated circuitry for processing and/or control. Integrated circuitry may include one or more processors 36, processor cores, field programmable gate arrays (FPGAs), application specific integrated circuits (ASICs), graphics processing units (GPUs), Systems on Chips (SoCs), configured to execute instructions. The processor 36 may be configured to access (e.g., write to and/or read from) the memory 38, which may comprise any kind of volatile and/or nonvolatile memory, e.g., cache, buffer memory, random access memory (RAM), read-only memory (ROM), optical memory, and/or erasable programmable read-only memory (EPROM). Further, memory 56 may be configured as a storage device.

Hardware 32 of remote server 30 may include communication interface 40 enabling remote server 30 to communicate with one or more elements in networked environment 10. For example, communication interface 40 may be configured for establishing and maintaining at least a wireless or wired connection with one or more elements of premises monitoring system 12 and/or other entities such as, internet service providers (ISPs), utility companies, etc.

Remote server 30 further has software 42 (which may include one or more software applications) stored internally in, for example, memory 38, or stored in external memory (e.g., database, storage array, network storage devices, etc.) accessible by the remote server 30 via an external connection. Software 42 may include any software or program configured to perform the steps or processes of the present disclosure.

The processing circuitry 34 may be configured to control and/or perform any of methods and/or processes described herein and/or to cause such methods, and/or processes to be performed, e.g., by remote server 30. Processor 36 corresponds to one or more processors 36 for performing remote server 30 functions described herein. The memory 38 is configured to store data and/or files such as computing environment data, status reports, power outage data, internet outage data, customer data (e.g., physical address) and/or other information/data. In some embodiments, the software 42 may include instructions that, when executed by the processor 36 and/or processing circuitry 34, causes the processor 36 and/or processing circuitry 34 to perform the processes described herein with respect to computing environment 14 such a via one or more remote servers 30. Accordingly, by having computer instructions stored in memory 38 accessible to the processor 36, the processor 36 may be configured to perform the functions described herein. Further, computing environment 14 may include a plurality of data stores 24.

Still referring to FIG. 2, premises monitoring system 12 comprises monitoring control device 12. Monitoring control device 20 comprises hardware 44. The hardware 44 may include processing circuitry 46. The processing circuitry 46 may include one or more processors 48 and one or more memories 50. Each processor 48 may include and/or be associated with one or more central processing units, data buses, buffers, and interfaces to facilitate operation. In addition to or instead of a processor 48 and memory, the processing circuitry 46 may comprise integrated circuitry for processing and/or control. Integrated circuitry may include one or more processors 48, processor cores, FPGAs, ASICs, GPUs, and/or SoCs configured to execute instructions. The processor 48 may be configured to access (e.g., write to and/or read from) the memory 50, which may comprise any kind of volatile and/or nonvolatile memory, e.g., cache, buffer memory, RAM, ROM, optical memory, and/or EPROM. Further, memory 50 may be configured as a storage device.

Hardware 44 of monitoring control device 20 may include communication interface 52 enabling monitoring control device 20 to communicate with one or more elements in networked environment 10. For example, communication interface 52 may be configured for establishing and maintaining at least a wireless or wired connection with one or more elements of premises monitoring system 12 and/or computing environment 14. Further, communication interface 52 may be configured to establish and maintain at least a wireless or wired connection with computing environment 14 such as with, for example, remote monitoring platform 22.

Monitoring control device 20 further has software 54 (which may include one or more software applications) stored internally in, for example, memory 50, or stored in external memory (e.g., database, storage array, network storage device, etc.) accessible by monitoring control device 20 via an external connection. Software 54 may include any software or program configured to perform the steps or processes of the present disclosure.

The processing circuitry 46 may be configured to control any of the methods and/or processes described herein and/or to cause such methods, and/or processes to be performed, e.g., by monitoring control device 20. Processor 48 corresponds to one or more processors 48 for performing monitoring control device 20 functions described herein. The memory 50 is configured to store data and/or files such as power outage data, internet outage data, customer data and/or other information/data. In some embodiments, the software 54 may include instructions that, when executed by the processor 48 and/or processing circuitry 46, cause the processor 48 and/or processing circuitry 46 to perform the processes described herein with respect to premises monitoring system 12. Accordingly, by having computer instructions stored in memory 50 accessible to the processor 48, the processor 48 may be configured to perform the actions described herein.

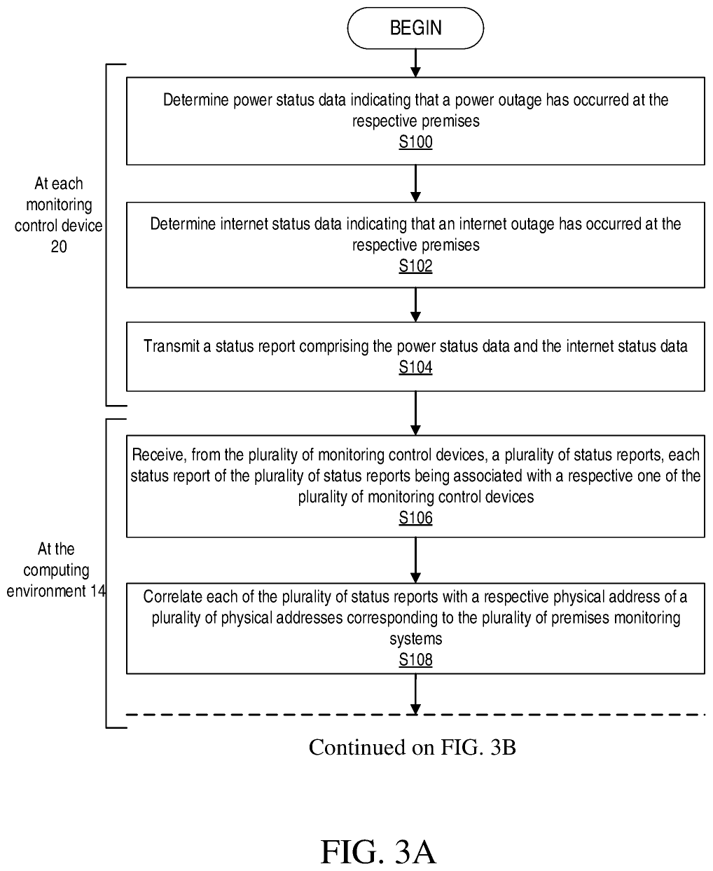

FIGS. 3A and 3B are a flow diagram of an example process performed by components of networked environment 10 according to one or more embodiments of the present disclosure. One or more blocks in FIGS. 3A-3B may be performed by computing environment 14, such as, for example, one or more of remote monitoring platform 22, data store 24, at least one remote server 30 (e.g., at least one computing device), processing circuitry 34, processor 36, communication interface 40, etc. One or more blocks in FIG. 3A-3B may also be performed by monitoring control device 20, such as, for example, processing circuitry 46, processor 48, communication interface 52, etc.

According to one or more embodiments, network environment 10 (e.g., system) comprises a plurality of monitoring control devices 20, where each of the plurality of monitoring control devices 20 are associated with a respective one of a plurality of premises monitoring systems 12 for monitoring a respective premises.

Beginning at Block S100, each of the plurality of monitoring control device 20 is configured to: determine power status data indicating that a power outage has occurred at the respective premises (Block 100), determine internet status data indicating that an internet outage has occurred at the respective premises (Block S102), and transmit a status report comprising the power status data and the internet status data (Block S104). For example, monitoring control device 20 may determine that power is no longer being received from a power outlet to which monitoring control device 20 is plugged into, and/or is no longer able to access the internet via a local wireless network.

The computing environment 14 is configured to receive, from the plurality of monitoring control devices, a plurality of status reports, each status report of the plurality of status reports being associated with a respective one of the plurality of monitoring control devices 20 (Block S106). The computing environment 14 is configured to correlate each of the plurality of status reports with a respective physical address of a plurality of physical addresses corresponding to the plurality of premises monitoring systems 12 (Block S108). The computing environment 14 is configured to determine that a power outage has occurred in a first geographical area covering at least a first subset of the plurality of addresses based at least on the plurality of status reports received from the monitoring control devices 20 (Block S110). In one or more embodiments, power outage may refer to a geographical power outage where a threshold amount of monitoring control devices 20 have indicated a power outage.

The computing environment 14 is configured to determine that an internet outage has occurred in a second geographical area covering at least a second subset of the plurality of addresses based at least on the plurality of status reports received from the monitoring control devices 20 (Block S112). In one or more embodiments, internet outage may refer to a geographical power outage where a threshold amount of monitoring control devices 20 have indicated an internet outage. The computing environment 14 is configured to initiate at least one action based at least on determining that the power outage and the internet outage has occurred (Block S114).

According to some embodiments, the computing environment 14 is further configured to: in response to determining the internet outage has occurred in the geographical area and for each of the plurality of monitoring control devices 20 that are physically located in the geographical area, determine an Internet Service Provider (ISP) used for internet access by the monitoring control device 20 and correlate the respective status report associated with the monitoring control device 20 with the ISP. The computing environment 14 is further configured to determine that the internet outage in the geographical area is associated with one ISP and not with another ISP based at least on each ISP correlated with each respective status report.

According to some embodiments, the computing environment 14 is further configured to: in response to determining the internet outage has occurred in the geographical area and for each of the plurality of monitoring control devices 20 that are physically located in the geographical area, request ISP data from the monitoring control device 20 and receive ISP data from the monitoring control device 20. the computing environment 14 is further configured to determine the ISP used for internet access by the monitoring control device 20 is based at least on the ISP data.

According to some embodiments, each of the plurality of monitoring control devices 20 that are physically located in the geographical area is configured to receive the request for the ISP data indicating the ISP used for internet access by the monitoring control device 20, and determine the ISP data based at least on at least one of a domain name system (DNS) associated with internet use by the monitoring control device 20 or an Internet Protocol (IP) address associated with intent use by the monitoring control device 20, or cause transmission of the ISP data.

According to some embodiments, the at least one action comprises notifying the first ISP of the internet outage.

According to some embodiments, computing environment 14 is further configured to determine that the internet outage has occurred in the geographical area is further based at least on: a quantity of the plurality of monitoring control devices 20, in a predefined area, that indicate the internet outage via the internet status data, and the quantity meeting a threshold number of monitoring control devices 20. For example, computing environment 14 is configured to use a predefined threshold or threshold that is based at least on at least one characteristic of a geographical area (e.g., size, population, etc.), to increase confidence that that an outage occurred. For example, as the size and/or population of the geographical area being analyzed decreases, the threshold value or quantity may also be decreased. In another example, as the size and/or population of the geographical area being analyzed increases, the threshold value or quantity may also be increased. In another example, computing environment 14 is configured to analyze a rate such as, for example, a quantity of status reports over a predefined period of time. For example, a determined or real-time rate of status reports, received by computing environment 14, can be compared to a rate threshold to determine that an outage occurred. The rate threshold may be predefined or may scale with one or more characteristics of a predefined area and/or geographical area, e.g., scale with a size of the population in an area. In some embodiments, only certain status reports may count towards the rate calculated by computing environment 14. For example, only status reports indicating a power outage and/or internet outage may be counted, or only status reports from a predefined area may be counted. In another example, all status reports received by computing environment 14 are counted for comparison with the predefined or scaled (e.g., dynamic) threshold.

According to some embodiments, the predefined area corresponds to an area defined by at least one of: a zip code, latitude and longitude coordinates, or an intersection of a plurality of streets.

According to some embodiments, the internet status data of at least one of the plurality of reports further indicates a time duration of the internet outage at the respective premises, and where computing environment 14 is further configured to determine that the internet outage has occurred in the geographical area further based at least on the time duration indicated in the internet status data of at least one of the plurality of reports.

According to some embodiments, computing environment 14 is further configured to determine that the power outage has occurred in the geographical area further based at least on: a quantity of the plurality of monitoring control devices 20 that indicated the power outage via the power status data, and where the quantity meeting a threshold number of monitoring control devices 20.

According to some embodiments, the computing environment 14 is further configured to: determine that at least one premises of the plurality of premises has a backup power source, and exclude the power status data corresponding to the at least one premises of the plurality of premises that has backup power when determining that the power outage or the internet outage has occurred. For example, the backup power source may be a solar power source or a power generator source such that the power status data from a premises with a backup power source may reduce the accuracy of the analysis of the computing environment 14. Therefore, computing environment 14 may remove this data point from the analysis, thereby helping increase the accuracy of the power outage analysis.

According to some embodiments, the at least one action comprises at least one of generate a notification for a plurality of customers associated with the geographical area where the notification indicates the geographical area and that the power outage or the internet outage has occurred in the geographical area.

According to some embodiments, monitoring control device 20 is further configured to provide status reports indicating when power (i.e., powered supplied by or at the premises) and/or Wi-Fi have been restored to the monitoring control device 20, thereby providing real-time monitoring of outages. That is, computing environment 14 may be able to track outages nationwide without having to interface with different Outage Management Systems. Further, computing environment 14 is able to track and/or analyze outages based at least on, for example, data received from monitoring control devices 20 during a time or instance when data collection in other Outage Management Systems may not be working such as during one or more of a natural disaster, cyber-attack, during a network bug, etc.

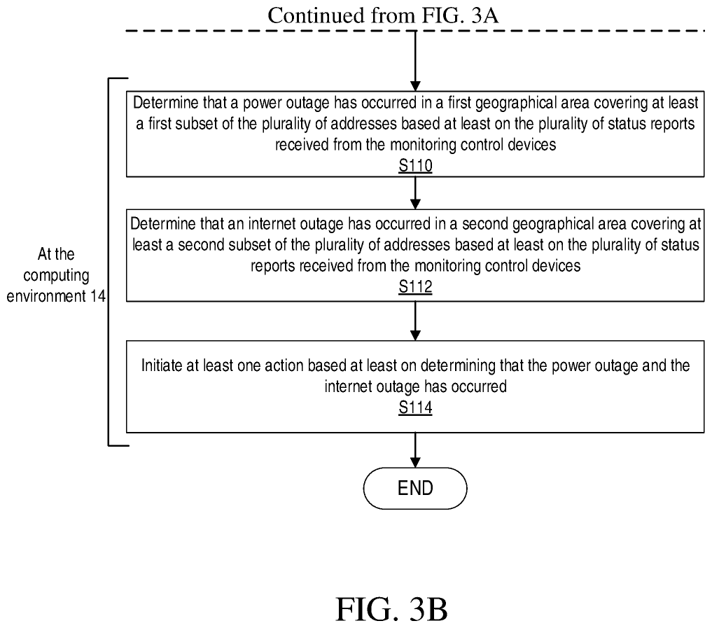

FIG. 4 is a diagram of an example grouping of status reports received from a plurality of premises monitoring systems 12 in geographical region 1. For example, the status reports indicate power status data (e.g., powered or unpowered) and internet status data (e.g., Wi-Fi or no Wi-Fi). In the example of FIG. 4, computing environment 14 may determine that no power outage and internet outage has occurred in geographical region 1 since, for example, the thresholds for such a determination are not met. In this example, only monitoring control device 20m has indicated that it can no longer access the internet via a local wireless connection but has power. Further, in this example, only monitoring control device 20n has indicated that it is no longer able to access the internet via a local wireless connection and it is no longer receiving power from the premises (e.g., the power outlet that monitoring control device 20n is plugged into is no longer providing power). Therefore, based at least on the threshold for determining whether an outage (i.e., geographical based power and/or internet outage) has occurred, computing environment 14 may determine no such outage has occurred for geographical region 1 even though at least one monitoring control device 20 has indicated no Wi-Fi and/or no power.

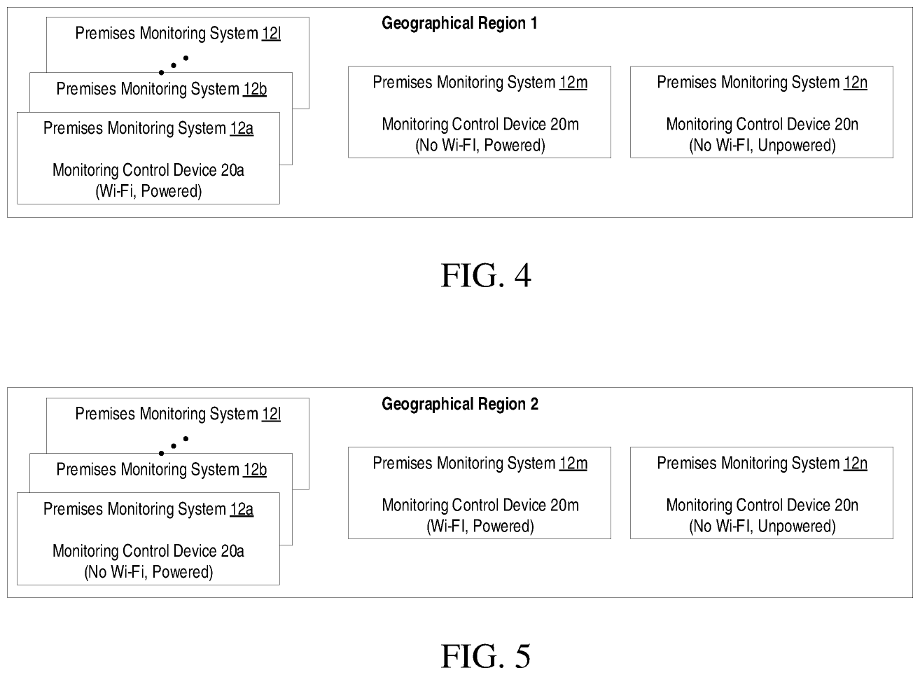

FIG. 5 is a diagram of another example grouping of status reports received from a plurality of premises monitoring systems 12 in geographical region 2. In this example, computing environment 14 determines an internet outage has occurred. Further, in some embodiments, computing environment 14 may further determine that the internet outage is specific to an ISP, as described herein. That is, computing environment 14 may determine that the internet outage only affects a first ISP while one or more other ISP are unaffected and are still providing internet access.

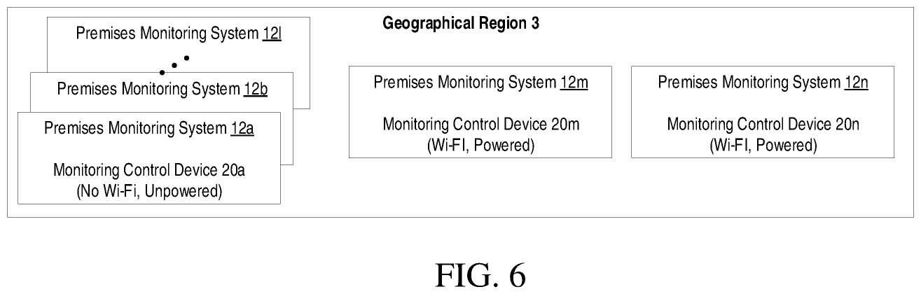

FIG. 6 is a diagram of another example grouping of status reports received from a plurality of premises monitoring systems 12 in geographical region 2. In this example, computing environment 14 determines an internet outage and a power outage has occurred based at least on different thresholds being met.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A system comprising:
a plurality of monitoring control devices, each of the plurality of monitoring control devices being associated with a respective one of a plurality of premises monitoring systems for monitoring a respective premises, each of the plurality of monitoring control devices comprising processing circuitry to:
determine power status data indicating that a power outage has occurred at the respective premises;
determine internet status data indicating that an internet outage has occurred at the respective premises; and
transmit a status report comprising the power status data and the internet status data;
a computing environment comprising at least one computing device, the at least one computing device comprising processing circuitry configured to:
receive, from the plurality of monitoring control devices, a plurality of status reports, each status report of the plurality of status reports being associated with a respective one of the plurality of monitoring control devices;
correlate each of the plurality of status reports with a respective physical address of a plurality of physical addresses corresponding to the plurality of premises monitoring systems;
determine that a power outage has occurred in a first geographical area covering at least a first subset of the plurality of addresses based at least on the plurality of status reports received from the monitoring control devices;
determine that an internet outage has occurred in a second geographical area covering at least a second subset of the plurality of addresses based at least on the plurality of status reports received from the monitoring control devices; and
initiate at least one action based at least on determining that the power outage and the internet outage has occurred.

2. The system of claim 1, wherein the processing circuitry of the at least one computing device is further configured to:
in response to determining the internet outage has occurred in the geographical area,
for each of the plurality of monitoring control devices that are physically located in the geographical area,
determine an Internet Service Provider (ISP) used for internet access by the monitoring control device;
correlate the respective status report associated with the monitoring control device with the ISP;
determine that the internet outage in the geographical area is associated with one ISP and not with another ISP based at least on each ISP correlated with each respective status report;

3. The system of claim 2, wherein the processing circuitry of the at least one computing device is further configured to:
in response to determining the internet outage has occurred in the geographical area and for each of the plurality of monitoring control devices that are physically located in the geographical area,
request ISP data from the monitoring control device;
receive ISP data from the monitoring control device; and
determine the ISP used for internet access by the monitoring control device based at least on the ISP data.

4. The system of claim 3, wherein the processing circuitry of each of the plurality of monitoring control devices that are physically located in the geographical area is configured to:
receive the request for the ISP data indicating the ISP used for internet access by the monitoring control device;
determine the ISP data based at least on at least one of:
domain name system (DNS) associated with internet use by the monitoring control device; or
Internet Protocol (IP) address associated with intent use by the monitoring control device; or
cause transmission of the ISP data.

5. A computing environment comprising at least one computing device, the computing environment being configured to communicate with a plurality of monitoring control devices, each of the plurality of monitoring control devices being associated with a respective one of a plurality of premises monitoring systems for monitoring a respective premises, the computing environment comprising:
processing circuitry configured to:
receive a plurality of status reports, each status report being associated with a respective one of the plurality of monitoring control devices and including at least one of power status data or internet status data for a respective premises;
correlate each of the plurality of status reports with a respective physical address of a plurality of physical addresses corresponding to the plurality of premises monitoring systems;
determine that at least one of a power outage or an internet outage has occurred in a geographical area covering at least a subset of the plurality of physical addresses based at least on the plurality of status reports received from the monitoring control devices; and
initiate at least one action based at least on determining that at least one of the power outage or the internet outage has occurred.

6. The computing environment of claim 5, wherein the processing circuitry is further configured to:
in response to determining that the internet outage occurred in the geographical area and for each of the plurality of monitoring control devices that are physically located in the geographical area,
determine an Internet Service Provider (ISP) used for internet access by the monitoring control device;
correlate the status report associated with the monitoring control device with the ISP; and
determine the internet outage in the geographical area is associated with a first ISP and not with a second ISP based at least on each ISP correlated with each respective status report.

7. The computing environment of claim 6, wherein the at least one action comprises notifying the first ISP of the internet outage.

8. The computing environment of claim 6, wherein the processing circuitry is further configured to:
in response to determining the internet outage has occurred in the geographical area and for each of the plurality of monitoring control devices that are physically located in the geographical area,
request ISP data from the monitoring control device;
receive ISP data from the monitoring control device; and
determine the ISP used for internet access by the monitoring control device based at least on the ISP data.

9. The computing environment of claim 5, wherein the processing circuitry is further configured to determine that the internet outage has occurred in the geographical area further based at least on:
a quantity of the plurality of monitoring control devices, in a predefined area, that indicate the internet outage via the internet status data; and
the quantity meeting a threshold number of monitoring control devices.

10. The computing environment of claim 9, wherein the predefined area corresponds to an area defined by at least one of:
a zip code;
latitude and longitude coordinates; or
an intersection of a plurality of streets.

11. The computing environment of claim 9, wherein the internet status data of at least one of the plurality of reports further indicates a time duration of the internet outage at the respective premises; and
wherein the processing circuitry is further configured to determine that the internet outage has occurred in the geographical area further based at least on the time duration indicated in the internet status data of at least one of the plurality of reports.

12. The computing environment of claim 5, wherein the processing circuitry is further configured to determine that the power outage has occurred in the geographical area further based at least on:
a quantity of the plurality of monitoring control devices that indicated the power outage via the power status data; and
the quantity meeting a threshold number of monitoring control devices.

13. The computing environment of claim 5, wherein the processing circuitry is further configured to:
determine that at least one premises of the plurality of premises has a backup power source; and
exclude the power status data corresponding to the at least one premises of the plurality of premises that has backup power when determining that the power outage or the internet outage has occurred.

14. The computing environment of claim 5, wherein the at least one action comprises at least one of:
generating a notification for a plurality of customers associated with the geographical area, the notification indicating:
the geographical area; and
that the power outage or the internet outage has occurred in the geographical area.

15. A method performed by a computing environment, the computing environment comprising at least one computing device and being configured to communicate with a plurality of monitoring control devices, each of the plurality of monitoring control devices being associated with a respective one of a plurality of premises monitoring systems for monitoring a respective premises, the method comprising:
receiving a plurality of status reports, each status report being associated with a respective one of the plurality of monitoring control devices and including at least one of power status data or internet status data for a respective premises;
correlating each of the plurality of status reports with a respective physical address of a plurality of physical addresses corresponding to the plurality of premises monitoring systems;
determining that at least one of a power outage or an internet outage has occurred in a geographical area covering at least a subset of the plurality of physical addresses based at least on the plurality of status reports received from the monitoring control devices; and
initiating at least one action based at least on determining that at least one of the power outage or the internet outage has occurred.

16. The method of claim 15, further comprising:
in response to determining that the internet outage occurred in the geographical area and for each of the plurality of monitoring control devices that are physically located in the geographical area,
determining an Internet Service Provider (ISP) used for internet access by the monitoring control device;
correlating the status report associated with the monitoring control device with the ISP; and
determining the internet outage in the geographical area is associated with a first ISP and not with a second ISP based at least on each ISP correlated with each respective status report.

17. The method of claim 16, wherein the at least one action comprises at least one of:
generating a notification for the first ISP of the internet outage; and
generating a notification for a plurality of customers associated with the geographical area, the notification for the plurality of customers indicating:
the geographical area; and
that the power outage or the internet outage has occurred in the geographical area.

18. The method of claim 15, further comprising:
determining that the internet outage has occurred in the geographical area further based at least on:
a quantity of the plurality of monitoring control devices, in a predefined area, that indicate the internet outage via the internet status data; and
the quantity meeting a threshold number of monitoring control devices; or
determining that the power outage has occurred in the geographical area further based at least on:
a quantity of the plurality of monitoring control devices, in the predefined area, that indicate the power outage via the power status data; and
the quantity meeting a threshold number of monitoring control devices.

19. The method of claim 18, wherein the predefined area corresponds to an area defined by at least one of:
a zip code;
latitude and longitude coordinates; or
an intersection of a plurality of streets.

20. The computing environment of claim 15, further comprising:
determining that at least one premises of the plurality of premises has a backup power source; and
excluding the power status data corresponding to the at least one premises of the plurality of premises that has backup power when determining that the power outage or the internet outage has occurred.
